(19) United States
(12) Patent Application Publication
(10) Pub. No.: US 2009/0303216 A1
(43) Pub. Date: Dec. 10, 2009

(54) DISPLAY DEVICE AND CONTROL METHOD THEREOF

(75) Inventor: Jun Ho SHIN, Gyoungsangbuk-do (KR)

Correspondence Address: FISH & RICHARDSON P.C., P.O. BOX 1022, MINNEAPOLIS, MN, 55440-1022, US

(73) Assignee: LG Electronics Inc., Seoul (KR)

(21) Appl. No.: 12/481,766

(22) Filed: Jun. 10, 2009

(30) Foreign Application Priority Data
Jun. 10, 2008 (KR) 10-2008-0053994
Jan. 21, 2009 (KR) 10-2009-0004967

(51) Int. Cl. G09G 5/10; G06F 3/038

(52) U.S. Cl. 345/207; 345/690

(57) ABSTRACT

Display device technology, in which an illumination sensor senses illumination of surroundings of a location where a display device is installed and image signals to be displayed are received. An average picture level of a received signal is detected and a controller controls brightness of a backlight associated with the display device based on the illumination sensed by the illumination sensor and the detected average pixel value.

### CROSS-REFERENCE TO RELATED APPLICATIONS

The present application claims priority under 35 U.S.C. 119 and 35 U.S.C. 365 to Korean Patent Application No. 10-2008-0053994 (filed on Jun. 10, 2008) and Korean Patent Application No. 10-2009-0004967 (filed on Jan. 21, 2009), which are hereby incorporated by reference in their entirety.

### FIELD

The present disclosure relates to display device technology.

### BACKGROUND

A liquid crystal display device using a liquid crystal display (LCD) controls light transmittance of liquid crystal cells according to a video signal, thereby displaying images. The liquid crystal display device is implemented by an active matrix type where switching devices are provided for each cell. In some examples, the liquid crystal display device is applied to a monitor for a computer, a business machine, a display device for a cellular phone, etc.

The liquid crystal display device of the active matrix type has used a thin film transistor (hereinafter, referred to as ‘TFT’) as the switching device. The liquid crystal display device controls the brightness of a display screen by controlling backlight brightness.

### SUMMARY

In one aspect, a display device includes an illumination sensor configured to sense illumination of surroundings of a location where the display device is installed and an image data receiver configured to receive image signals to be displayed. The display device also includes a picture level detector configured to detect and output an average picture level of a signal received by the image data receiver and a controller configured to control brightness of a backlight associated with the display device based on the illumination sensed by the illumination sensor and the average pixel value output by the picture level detector.

Implementations may include one or more of the following features. For example, the display device may include a memory unit configured to store data related to backlight control values corresponding to illumination levels. In this example, the controller may be configured to control brightness of the backlight associated with the display device based on the illumination sensed by the illumination sensor and the average pixel value output by the picture level detector by accessing, from the memory unit, data corresponding to an illumination level sensed by the illumination sensor and setting at least one register value that controls the brightness of the backlight using the accessed data and the average pixel value output by the picture level detector.

The illumination levels may be grouped for each of multiple predetermined ranges, and the data related to backlight control values corresponding to illumination levels stored in the memory unit may include an equation corresponding to each illumination group. The equation corresponding to each illumination group may be a linear equation having average pixel level as an independent variable, a coefficient for the independent variable, and a constant. The controller may be configured to set the at least one register value as a result of the equation using the average pixel value output by the picture level detector.

The illumination levels may be grouped for each of multiple predetermined ranges, and the data related to backlight control values corresponding to illumination levels stored in the memory unit may be register values for each average pixel level corresponding to each illumination group. The register values may be determined based on a picture level of the display device needed to reduce unified glare rating values below specific levels for the illumination sensed by the illumination sensor. The register values may be in inverse proportion to the illumination levels.

In some implementations, the controller may be further configured to control brightness of the backlight associated with the display device based on an amount of time during which the backlight has been in use. In these implementations, the controller may be configured to control brightness of the backlight associated with the display device based on the amount of time during which the backlight has been in use by determining the amount of time during which the backlight has been in use and adjusting at least one set register value that controls the brightness of the backlight in a manner corresponding to the determined amount of time during which the backlight has been in use.

In some examples, the controller may be further configured to control brightness of the backlight associated with the display device based on an extent of a variation of the average pixel level output through the picture level detector. In these examples, the controller may be configured to control brightness of the backlight associated with the display device based on the extent of the variation of the average pixel level output through the picture level detector by determining the extent of the variation of the average pixel level output through the picture level detector, comparing the extent of the variation of the average pixel level to a pre-set level, determining whether the extent of the variation of the average pixel level exceeds the pre-set level based on the comparison, and, in response to a determination that the extent of the variation of the average pixel level exceeds the pre-set level, dividing a change period of the average pixel level into steps and sequentially adjusting the brightness of the backlight associated with the display device according to the steps.

In another aspect, a method of controlling a display device includes sensing, by an illumination sensor, illumination of surroundings of a location where the display device is installed and receiving image signals to be displayed. The method also includes detecting an average picture level of a received signal and controlling, by a controller, brightness of a backlight associated with the display device based on the illumination sensed by the illumination sensor and the detected average pixel value.

Implementations may include one or more of the following features. For example, the method may include storing, in a memory unit, data related to backlight control values corresponding to illumination levels. In this example, the may include accessing, from the memory unit, data corresponding to an illumination level sensed by the illumination sensor and setting at least one register value that controls the brightness of the backlight using the accessed data and the detected average pixel value.

The method further may include grouping the illumination levels for each of multiple ranges and storing an equation corresponding to each illumination group. In addition, the method may include grouping the illumination levels for each of multiple ranges and storing register values for each average pixel level corresponding to each illumination group.

In some implementations, the method may include controlling brightness of the backlight associated with the display device based on an amount of time during which the backlight has been in use. In these implementations, the method may include determining the amount of time during which the backlight has been in use and adjusting at least one set register value that controls the brightness of the backlight in a manner corresponding to the determined amount of time during which the backlight has been in use.

In some examples, the method may include controlling brightness of the backlight associated with the display device based on an extent of a variation of the detected average pixel level. In these examples, the method may include determining the extent of the variation of the average pixel level output through the picture level detector, comparing the extent of the variation of the average pixel level to a pre-set level, and determining whether the extent of the variation of the average pixel level exceeds the pre-set level based on the comparison. In response to a determination that the extent of the variation of the average pixel level exceeds the pre-set level, the method may include dividing a change period of the average pixel level into steps and sequentially adjusting the brightness of the backlight associated with the display device according to the steps.

In yet another aspect, at least one computer-readable storage medium encoded with executable instructions that, when executed by a processor, cause the processor to perform operations. The operations include controlling an illumination sensor to sense illumination of surroundings of a location where a display device is installed and receiving image signals to be displayed. The operations also include detecting an average picture level of a received signal and controlling brightness of a backlight associated with the display device based on the illumination sensed by the illumination sensor and the detected average pixel value.

Implementations of any of the techniques described throughout the disclosure may include a method or process, a system, or instructions stored on a computer-readable storage device. The details of particular implementations are set forth in the accompanying drawings and description below. Other features will be apparent from the following description, including the drawings, and the claims.

### BRIEF DESCRIPTION OF THE DRAWINGS

FIGS. 1 and 2 are diagrams for explaining an example method of controlling backlight brightness;

FIG. 3 is a diagram showing an example configuration of a display device;

FIGS. 4 and 5 are diagrams for explaining an example operation method of using unified glare rating (UGR) values;

FIGS. 6 and 7 are diagrams for explaining an example process;

FIG. 8 is a diagram for explaining an example brightness control table;

FIG. 9 is a diagram for explaining an example relationship between an accumulated use time of a backlight and backlight brightness;

FIG. 10 is a diagram for explaining an example operation of controlling backlight brightness in response to a sudden change in an average picture level (APL);

FIG. 11 is a flowchart for explaining an example method of controlling a display device;

FIG. 12 is a flowchart for explaining an example method of determining an equation;

FIG. 13 is a flowchart for explaining an example method of changing register values; and

FIG. 14 is a flowchart for explaining an example method of applying register values.

### DETAILED DESCRIPTION

Techniques are described for controlling brightness of a backlight associated with a display device, such as a liquid crystal display. In some examples, the display device senses illumination of surroundings of a location where the display device is installed and receives image signals to be displayed. In these examples, the display device detects an average picture level of a received signal and controls brightness of a backlight associated with the display device based on the illumination sensed and the detected average pixel value. Controlling backlight brightness based on both illumination sensed and average pixel value may improve a viewing experience of a user using the display device.

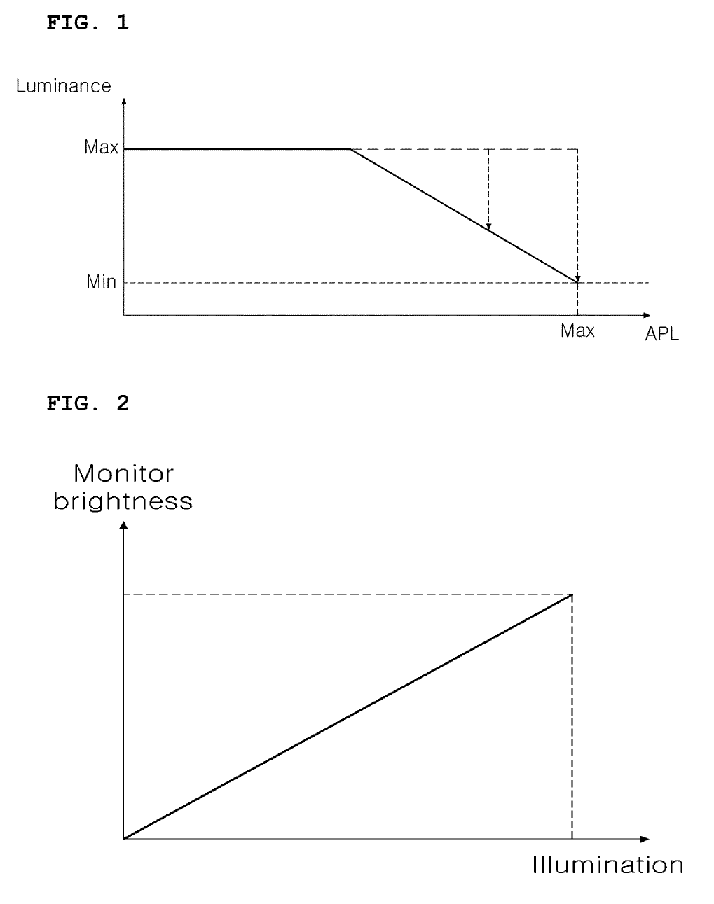

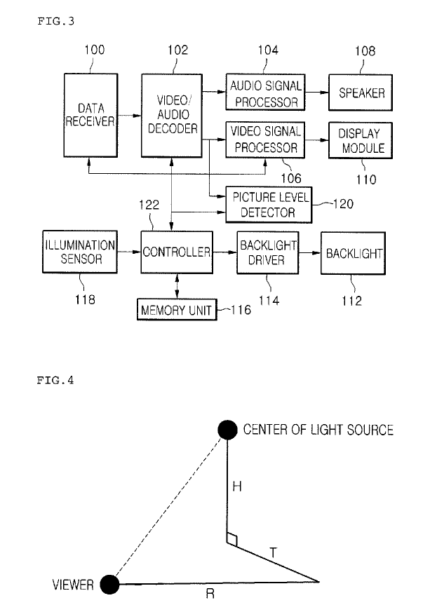

FIG. 1 illustrates an example of a method of controlling backlight brightness in inverse proportion to an average brightness level of input image data and FIG. 2 illustrates an example of a method of controlling the backlight brightness in proportion to illumination of surroundings of a location where a display device is installed. In some implementations, the methods shown in FIGS. 1 and 2 may be improved by accounting for both the average brightness level of input image data and the illumination of the surroundings of the location where the display device is installed in controlling the backlight brightness.

FIG. 3 illustrates an example configuration of a display device. As shown, a display device includes a data receiver 100, a video/audio decoder 102, an audio signal processor 104, a speaker 108, a video signal processor 106, a display module 110, a backlight 112, a backlight driver 114, a memory unit 116, an illumination sensor 118, a picture level detector 120, and a controller 122.

The data receiver 100 receives data input from an external source. For instance, the data receiver 100 may receive audio/video signals, image data, or any other type of data to be output by the display device.

In some implementations, the data receiver 100 may be a digital tuner that receives digital broadcasting signals, an analog tuner that receives analog broadcasting signals, digital external signal input terminals and analog signal input terminals to which external devices (e.g., a digital video disc (DVD) player, a video game console, etc.) are connected, and a digital recorder, such as a personal video recorder (PVR) and a digital video recorder (DVR). The digital external signal input terminal may be an input terminal for a digital cable broadcasting signal or a terminal to which a digital media player, such as a DVD player, can be connected. The analog external signal input terminal may be an input terminal to which an analog media player, such as a videocassette recorder (VCR), can be connected or an input terminal for an analog cable broadcasting signal.

Further, the digital tuner may be configured to tune, from among the transmission streams (TS) that are included in a digital broadcasting signal input through an antenna for digital broadcasting, a transmission stream of a desired channel based on a selection of a user. The analog tuner may be configured to tune, from among image programs that are included an analog broadcasting signal input through an antenna for analog broadcasting, image programs of a desired channel based on a selection of a user.

Therefore, the data received through the data receiver 100 may include an analog television broadcasting program and a digital broadcasting program that are being broadcasted in real time, a reproducing program input from an external player, a recording program, and a cable broadcasting program. When the data received includes digital signals, the digital signals may include an image signal, voice signals, and data signals. When the data received includes analog signals, the analog signals may include image signals and voice signals.

The video/audio decoder 102 decodes video signals and audio signals in the data received through the data receiver 100 and transmits the decoded signals to the audio signal processor 104 and the video signal processor 106, respectively.

The audio signal processor 104 performs signal processes, such as digitalization, filtering, etc., on the audio signals transmitted from the video/audio decoder 102 and the processed audio signals are output through the speaker 106.

The video signal processor 106 performs signal processes, such as digitalization, filtering, etc., on the video signals transmitted from the video/audio decoder 102 and the processed video signals are displayed through the display module 110.

In some implementations, the video signal processor 106 is configured to include the picture level detector 120 that detects an average picture level (APL) for each frame of an input image. In other implementations, the picture level detector 120 is a separately configured unit from the video signal processor 106.

The picture level detector 120 measures the APL for each frame of the image data input through the data receiver 100 and transmits the measured APL to the controller 122. The APL corresponds to one of the image features for the input image data and the picture level control of the display device is performed according to the measured APL based on data for backlight control values corresponding to illumination levels, as described in more detail below.

The display module 110 may include a liquid crystal panel that includes a plurality of gate lines and LCD transistors, a data driver that drives the plurality of data lines according to video signals processed by the video signal processor 106, and a gate driver that receives driving signals from a timing controller and drives the plurality of gate lines.

The backlight 112 supplies light to a front surface of the light crystal panel. The backlight 112 may include a plurality of backlights that are installed to be overlapped with the liquid crystal panel.

The backlight driver 114 supplies a driving current to the backlight 112 according to register values transmitted through the controller 122. The liquid crystal panel may have a high picture and a wide light emitting surface.

Even when image signals are displayed through the display module 110, if the backlight 112 is not driven, a user has difficulty viewing the displayed images through the display module 110. In other words, when the backlight 112 receiving the driving current through the backlight driver 114 is light-emitted, the user more easily view the displayed image through the display module 110.

In addition, the screen brightness of the display module 110 is controlled by changing the driving current values supplied to the backlight 112 through the controller 122, such that the brightness of the displayed screen is changed according to whether the driving current values supplied to the backlight 112 are high or not.

The memory unit 116 stores programs related to the operation of the display device and various data generated during the operation of the display device. Further, the memory unit 116 stores the obtained data in correspondence with product model information on the display device.

The measured illumination level for each predetermined period may be generated and stored in the memory unit 116 for each illumination group. In addition, the data stored in the memory unit 116 may include an equation corresponding to each illumination group and/or register values for each APL corresponding to each illumination group. Further, the data stored in the memory unit 116 may be generated and stored based on the picture level of the display device according to the illumination sensing state in order to reduce unified glare rating (UGR) values below specific levels.

The above-referenced equation uses the average picture levels as first variables, and is a linear equation including a and b, which are a coefficient and a constant of the first variable. The solutions (e.g., second variables) obtained through the linear equation are set to the register values for controlling the picture level of the display device. In other words, the second variables are set to the register values for controlling the brightness of the backlight.

The linear equation may be obtained based on the register values that correspond to maximum average picture levels belonging to the same group from the picture levels of the display device according to the illumination sensing state, first coordinate information including minimum average picture level values, register values corresponding to the minimum average picture levels, and second coordinate information including the maximum picture level values. The process of obtaining the equation will be described in more detail below.

In addition, the memory unit 116 can be implemented by a nonvolatile memory, which updates and cancels data, for example, an Electrically Erasable Programmable Read only Memory (EEPROM) and/or an Extended Display Identification Data ROM (EDID ROM) and may be connected to the controller 122 according to an Inter-Integrated Circuit (I2C) scheme.

The illumination sensor 118 senses illumination of a location (e.g., surroundings) where the display device is installed. In other words, the illumination sensor 118 includes a photo sensor that converts light signals from outside of the display device into electrical signals and senses the external illumination by measuring the electrical signals.

The controller 122 extracts the data corresponding to the illumination sensing state sensed through the illumination sensor 118 from the memory unit 116. The register values for controlling the picture levels (e.g., backlight brightness) of the display device are set by using the extracted data and the APL detected through the picture level detector 120.

The process of generating the data and the operation of the controller 122 will be described in more detail below. The data may be the equation (or results of the equation) as described above and/or may be a table in which the applied register values are included.

Generally, unpleasant glare criteria are understood by using the unified glare rating (UGR) system. The UGR system generally indicates the unpleasant glare criteria as the values between 10 and 30. As the UGR value is reduced, the unpleasant glare is also reduced and as the UGR value is increased, the unpleasant glare is increased. In addition, the UGR can be applied by integrating all the light sources and can also be evaluated in a point light source.

The basic equation of the UGR is as follows.

$$UGR = 8 log [ \frac{0.25}{{L}_{b}} \sum \frac{{L}_{5}^{2} ω}{{P}^{2}} ] \qquad [ Equation 1 ]$$

where Lb: Luminance of background [cd/m2]

Ls: Luminance of emission portion of light source within observer sight;

ω: steradian of emission portion of light source within observer sight; and

P: position index of Guth of each light source.

The UGR value obtained through equation 1 is evaluated by glare criteria. The glare criteria are as follows.

TABLE 1

| Mean Response | UGR |
|---|---|
| Just Imperceptible | 10 |
| Perceivable | 16 |
| Just Acceptable | 19 |
| Inacceptable | 22 |
| Just Uncomfortable | 25 |
| Uncomfortable | 28 |
| Just Intolerable | 31 |

In other words, the UGR value exceeds 10, it may give inconvenience to a user or cause eye fatigue of the user.

Therefore, the present disclosure sets a picture level of a display device according to surrounding illumination, targeting the UGR value ranging from 9 to 10 (e.g., less than 10).

To this end, it is considered how the UGR value is changed in correspondence with the illumination at the surrounding where the display device is installed. In addition, if the change of the URG value according to the surrounding illumination is considered, a picture level Ls of the display device where the UGR value is between 9 to 10 is obtained.

TABLE 2

| | | background | monitor | | |
|---|---|---|---|---|---|
| Group | illumination | illumination | luminance(Ls) | ω | UGR |
| 0 | 700 | 350 | 300 | 0.3225 | 10.53 |
| | 690 | 345 | 296 | 0.3225 | 10.49 |
| | 680 | 340 | 290 | 0.3225 | 10.45 |
| | 670 | 335 | 288 | 0.3225 | 10.40 |
| | 660 | 330 | 284 | 0.3225 | 10.36 |
| | 650 | 325 | 280 | 0.3225 | 10.31 |
| | 640 | 320 | 276 | 0.3225 | 10.27 |
| | 630 | 315 | 272 | 0.3225 | 10.22 |
| | 620 | 310 | 268 | 0.3225 | 10.17 |
| | 610 | 305 | 264 | 0.3225 | 10.12 |
| | 600 | 300 | 260 | 0.3225 | 10.07 |
| | 590 | 295 | 256 | 0.3225 | 10.03 |
| | 580 | 290 | 250 | 0.3225 | 9.92 |
| | 570 | 285 | 248 | 0.3225 | 9.92 |
| 1 | 560 | 280 | 244 | 0.3225 | 9.87 |
| | 550 | 275 | 240 | 0.3225 | 9.82 |
| | 540 | 270 | 236 | 0.3225 | 9.77 |
| | 530 | 268 | 232 | 0.3225 | 9.71 |
| | 520 | 260 | 228 | 0.3225 | 9.66 |
| | 510 | 255 | 224 | 0.3225 | 9.60 |
| 2 | 500 | 250 | 220 | 0.3225 | 9.55 |
| | 490 | 245 | 218 | 0.3225 | 9.55 |
| | 480 | 240 | 216 | 0.3225 | 9.56 |
| | 470 | 235 | 214 | 0.3225 | 9.57 |
| | 460 | 230 | 212 | 0.3225 | 9.58 |
| | 450 | 225 | 210 | 0.3225 | 9.59 |
| | 440 | 220 | 208 | 0.3225 | 9.60 |

In other words, when the surrounding illumination is 640 as shown in Table 2, a picture value of the display device should be 276 in order to set the UGR value to 10.27.

ω=emission area/(viewing distance*viewing distance) [Equation 2]

$$\frac{1}{p} = [ \frac{{d}^{2}}{( 0.97 \times {d}^{2} + 2.3 \times d + 4 )} - 0.1 ] \times {e}^{( - 0.17 \frac{{s}^{2}}{d} 0.01 \text{?} \frac{{s}^{2}}{d} )} + 0.09 + \frac{( 0.075 - \frac{0.03}{d} )}{[ 1 + 3 \times {( s - 0.5 )}^{2} ]} \\ \text{?} \text{indicates text missing or illegible when filed} \qquad [ Equation 3 ]$$

In order to obtain UGR value using equation 1, ω value and p value should be obtained using equation 2 and equation 3.

The ω value may vary between display device models. In other words, the ω value may vary according to inch information on the display device so that the data should be obtained according to the model information on the display device. Hereinafter, a 22 inch model will be described by way of example.

When a display device is 22 inches, emission area becomes (0.43*2700) cm². Also, a viewing distance of a user is generally about 60 cm so that the ω value will be obtained based thereon. However, the present disclosure is not limited thereto, and other viewing distances may be used. Therefore, when the display device is 22 inch, the ω value becomes 0.3225.

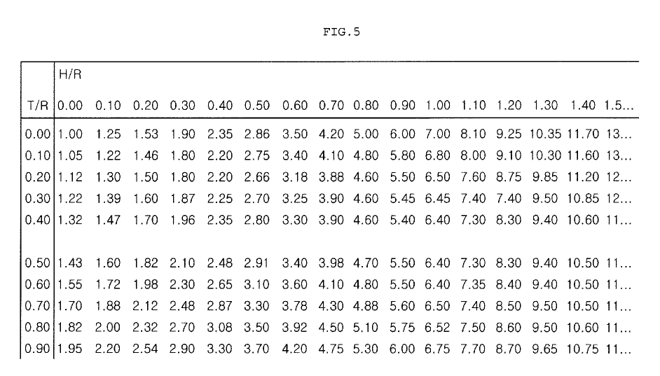

In order to determine the p value using equation 3, H, T and R values should be first obtained as shown in FIG. 4.

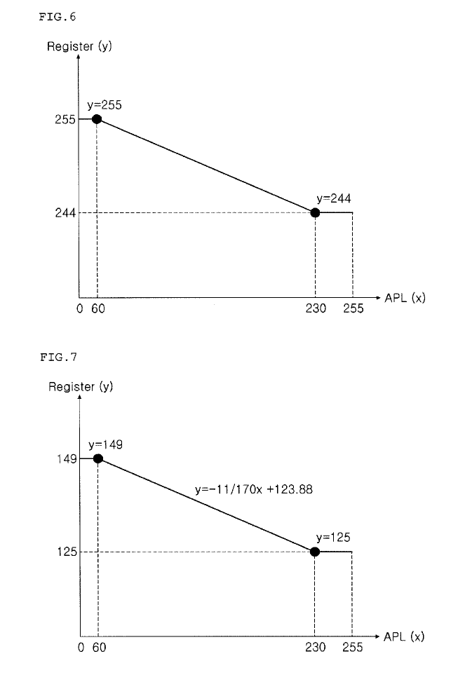

In some examples, the center of the emission area of the display device is horizontal with the user under a normal viewing condition, such that the H and T values become 0. Therefore, when the H and T values become 0, the T/R and H/R values shown in FIG. 5 also become 0 so that the p value becomes 1.

If the ω value, the p value, and the illumination level Lb value obtained as above are used in equation 1, and the UGR value to be targeted is used for the left term thereof, the Ls value that is the picture level of the display device can be computed.

The picture level of the display device obtained as above may be applied continuously, but, in some examples, a predetermined number of illumination levels are grouped as one group and data for setting picture levels of the display device to be applied according to the group is obtained.

For example, if illumination levels ranging from 560 to 510 are grouped as one group, the picture level of the display device to be applied exists within the range from 244 to 224. In other words, if the currently sensed surrounding illumination is within the range from 560 to 510, the picture level of the display device is varied only within the range from 224 to 244.

The picture level of the display device may not be randomly varied within the range. In some examples, the picture level of the display device is varied in inverse proportion to an APL value of input image data. In these examples, in order to vary the picture level of the display device in inverse proportion to the APL value, an equation for setting the picture level of the display device corresponding to the APL value should be obtained.

Meanwhile, the picture level of the display device is a picture level that checks the picture level substantially emitted outside the display device, such that it cannot be a substantial application data value. The picture of the display device depends on the brightness of the backlight. Therefore, a register value that indicates the brightness of the backlight corresponding to the picture level of the display exists. The relation between the picture level of the display device and the register value is as follows.

TABLE 3

| Register | Luminance |
|---|---|
| 255 | 244 |
| 254 | 244 |
| 253 | 242 |
| 252 | 240 |
| 251 | 238 |
| 250 | 236 |
| 249 | 234 |
| 248 | 232 |
| 247 | 230 |
| 246 | 228 |
| 245 | 226 |
| 244 | 224 |
| 243 | 222 |

In order to set the picture level of the display device to 244 as shown in Table 3, the register value should be set to 255 or 254. Also, the register value, which is used in controlling the backlight of the display device, is included within the range from 0 to 255, and when the register value is set to 244, the picture level of the display device becomes 224 and a backlight current value corresponding thereto is provided. Therefore, the equation is an equation for obtaining the resister value, wherein variables for an average picture level of the input image data are included.

As shown in Table 2, the picture levels of the display device to be applied according to the illumination levels are obtained and then illumination levels having a predetermined range are grouped as one group. For example, illumination levels ranging from 560 to 510 are grouped as one group, and illumination levels ranging from 500 to 440 are grouped as another group.

As described above, if illumination levels having a predetermined range are grouped as one group, equations corresponding to each group are obtained. For example, a first group grouping the illumination levels ranging from 560 to 510 will be described. Equations for other groups of illumination levels may be determined using similar techniques.

In the case of the first group, the picture level of the display device that can be displayed exists within the range from 224 to 244. In other words, when the current illumination level is 550, the picture level of the display device thereof should be varied within the range from 224 to 244.

In some implementations, the picture level of the display device is varied in inverse proportion to the APL of the input image data.

In some examples, an equation can be obtained only when two or more coordinate values are understood. Therefore, in order to obtain an equation corresponding to the first group in these examples, two coordinate values should be obtained.

In order to obtain the coordinate values, a register value corresponding to a maximum value of the picture level of the display device and a register value corresponding to a minimum value thereof, belonging to the first group, and a maximum APL and a minimum APL of the input image data should be understood.

The APL of the input image data is generally indicated within the range from 0 to 255. However, the level indication within the ranges from 0 to 60, and from 230 to 255, may not be used, such that the picture level of the display device is controlled only within the range from 60 to 230.

Therefore, the maximum value of the picture level of the display device is 244 and the minimum value thereof is 224, and accordingly, the resister value corresponding to the maximum value of the picture level of the display device is 255 and the register value corresponding to the minimum value thereof is 244. Also, the maximum APL becomes 230 and the minimum APL becomes 60.

In addition, as shown in FIG. 6, the y axis represents a register value and the x axis represents an APL value, wherein the two values are in inverse proportion, such that one coordinate value becomes (60, 255) and the other coordinate value becomes (230, 244).

y=ax+b [Equation 4]

Also, because a general linear equation is the same as shown in equation 4, the obtained two coordinate values are substituted for equation 4, respectively, and the a value and the b value are obtained accordingly. In this manner, the equation for the first group becomes y=(−11/170)x+258.88 as shown in FIG. 6.

Equations for other groups can be also obtained in the same manner, respectively. For example, in the case when the coordinate values are (60, 149) and (230, 125) as shown in FIG. 7, an equation of y=(−11/170)x+123.88 is obtained.

TABLE 4

| Model | illumination(Lux) | Equation(x = APL, y = register) |
|---|---|---|
| W1953T | More than 680 | y = 255 |
| | 640~680 | y = (−11/170)x + 255.88 |
| | 570~639 | y = (−11/170)x + 246.88 |
| | 500~639 | y = (−11/170)x + 220.88 |
| | 430~499 | y = (−11/170)x + 199.88 |
| | 350~429 | y = (−11/170)x + 187.88 |
| | 270~349 | y = (−11/170)x + 175.88 |
| | 170~269 | y = (−11/170)x + 162.88 |
| | 110~169 | y = (−11/170)x + 140.88 |
| | 0~109 | y = (−11/170)x + 122.88 |
| W1954TQ | More than 680 | y = 255 |
| | 640~680 | y = (−11/170)x + 258.88 |
| | 570~639 | y = (−11/170)x + 246.88 |
| | 500~639 | y = (−11/170)x + 232.88 |
| | 430~499 | y = (−11/170)x + 216.88 |
| | 350~429 | y = (−11/170)x + 206 |
| | 270~349 | y = (−11/170)x + 193 |
| | 170~269 | y = (−11/170)x + 177.88 |
| | 110~169 | y = (−11/170)x + 157.88 |
| | 0~109 | y = (−11/170)x + 135.88 |
| W2253TQ | More than 680 | y = 255 |
| | 640~680 | y = (−11/170)x + 258.88 |
| | 570~639 | y = (−11/170)x + 246.88 |
| | 500~639 | y = (−11/170)x + 232.88 |
| | 430~499 | y = (−11/170)x + 216.88 |
| | 350~429 | y = (−11/170)x + 205 |
| | 270~349 | y = (−11/170)x + 192 |
| | 170~269 | y = (−11/170)x + 175.88 |
| | 110~169 | y = (−11/170)x + 153.88 |
| | 0~109 | y = (−11/170)x + 134.88 |
| W2254TQ | More than 680 | y = 255 |
| | 640~680 | y = 255 |
| | 570~639 | y = (−11/170)x + 258.88 |
| | 500~639 | y = (−11/170)x + 237.88 |
| | 430~499 | y = (−11/170)x + 212.88 |
| | 350~429 | y = (−11/170)x + 198 |
| | 270~349 | y = (−11/170)x + 184 |
| | 170~269 | y = (−11/170)x + 167.88 |
| | 110~169 | y = (−11/170)x + 146.88 |
| | 0~109 | y = (−11/170)x + 123.88 |

Equations according to model names of the respective display devices can be obtained through the above methods, as shown in the examples illustrated in Table 4.

Therefore, the controller 122 extracts an equation corresponding to an illumination sense state sensed through the illumination sensor 118 from the memory unit 116.

The controller 122 applies the register value with the APL detected through the picture level detector 120 using the extracted equation, and controls the picture level of the display device by applying the register value.

In further implementations, the data used by the controller 122 may be a brightness control table including a substantial register value. Also, the brightness control table exists according to illumination groups similar to the equation.

For example, the memory unit 116 stores a brightness control table applied when the surrounding illumination is 0 to 100 lux, a brightness control table applied when the surrounding illumination is 101 to 200 lux, and a brightness control table applied when the surrounding illumination is 201 to 300 lux, respectively.

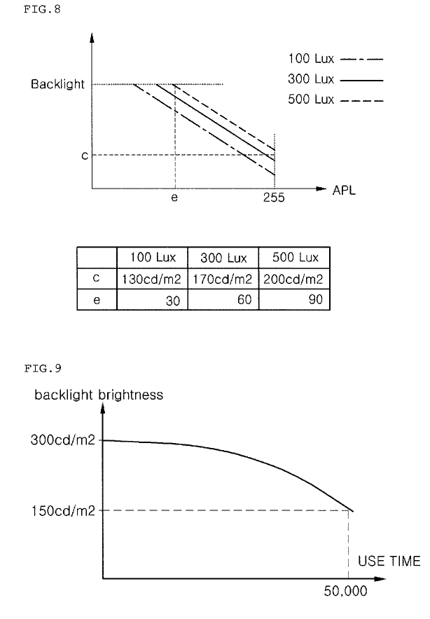

In other words, as shown in FIG. 8, the memory unit 116 is provided with the respective brightness control tables applied according to illumination at the surroundings where the display devices are currently installed. The brightness control tables include register values according to an average picture level. In other examples, the memory unit 116 stores only a specific brightness control table according to reference illumination and a brightness control table corresponding to another illumination is generated using the specific brightness table.

The controller 122 extracts a brightness control table according to an illumination sense state sensed through the illumination sensor 118 from the memory unit 116, and sets a register value for controlling the brightness of the backlight using the extracted brightness control table and the detected APL.

The controller 122 also counts (e.g., continuously) the passage of use time of the backlight and stores it in the memory unit 116. The controller 122 selectively changes the set register value in a manner corresponding to the stored passage of use time of the backlight. For instance, for the backlight 112, which is a consumption product, if the passage of use time passes by a predetermined time, brightness of light generated is varied. In other words, the brightness of the backlight is reduced as the passage of use time is increased.

As shown in FIG. 9, the life span of the backlight is about 50000 hours, and if the passage of use time of the backlight passes by 50000 hours, the brightness of the backlight is reduced to about a half of the brightness at the time of initial buying in a state the same register value is applied. Therefore, if the passage of use time of the backlight passes by a predetermined time, the controller 122 increases the set register value in proportion to the passage of use time of the backlight.

For example, if the determined register value is 200 and the passage of use time of the backlight passes by a predetermined time, the set register value is increased by a predetermined level (for example, 10). Assuming that if the register value is set to 255 at the time of initial buying of the display device, the brightness of the backlight is set to 244, and if the register value is set to 270 in a state where the passage of use time of backlight passes by a predetermined time, the brightness of the backlight is set to 244, the controller does not set the register value to 255, but sets the register value to 270 in order to set the brightness of the backlight to 244. Therefore, the display device compensates for the reduction of brightness of an output screen that occurs due to the passage of use time of the backlight, making it possible to provide an image screen of consistent or high image quality to a user throughout a lifetime of the display device.

The controller 122 checks an APL for each frame detected through the picture level detector 120, and selectively controls the register value when the APL variation between frames exceeds a predetermined level. For instance, when the APL of received image data is suddenly changed to n->m or m->n, if the register value is changed into a register value corresponding to the m in a state where the register value corresponding to the n is set, a screen noise phenomenon according to a sudden change in the brightness of the backlight may be generated. Therefore, if the APL variation between the detected frames exceeds a predetermined level, the controller 122 divides a variation region of the APL into predetermined steps, and sequentially applies register values according to the corresponding APL divided step by step.

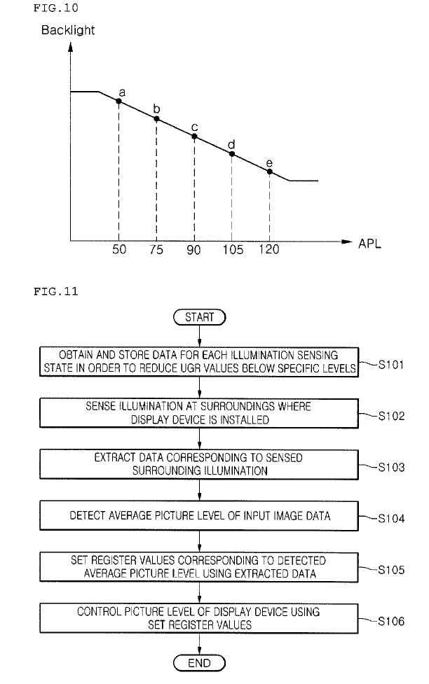

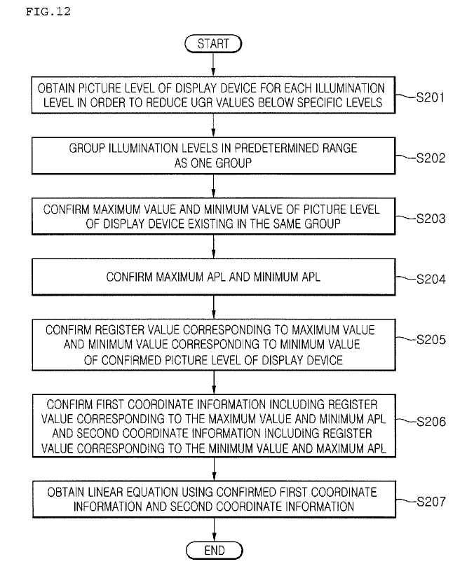

For example, as shown in FIG. 10, when the APL for a previous frame is 50 and the APL for a current frame is 120, the variation of the APL becomes 70. Also, if the variation of the APL exceeds 50, the aforementioned noise phenomenon may occur. Therefore, because the variation of the APL is 70 in this example, the variation region of the APL is divided into predetermined steps. In this regard, the variation region of the APL becomes 50 to 120, and the region ranging from 50 to 120 is divided into predetermined steps. Also, the number of divided steps and distance between steps (e.g., equal distance, etc.) may be determined based on user preference. In this example, the variation region is divided into four steps.

As shown, if the variation region is divided into four steps, the APL becomes 75 in the first step, the APL becomes 90 in the second step, the APL becomes 105 in the third step, and the APL becomes 120 in the fourth step. The register value corresponding to the first step is b, the register value corresponding to the second step is c, the register value corresponding to the third step is d, and the register value corresponding to the fourth step is e. Therefore, although a previously set register value is “a” and a register value to be currently set is “e,” the b, c, d, e values are sequentially applied, rather than the e value being applied directly. This may reduce the perception of a user of the variation (e.g., noise) of the backlight brightness.

The brightness of the backlight is varied according to the brightness at the surroundings where the display device is installed and the brightness level of the input image data, making it possible to reduce the eye fatigue of the user due to the continuous viewing of the display device as well as significantly reduce power consumption according to the change in current supplied to the backlight.

In addition, the backlight brightness changed according to the passage of use time of the display device is compensated, making it possible to provide the image screen of consistent or high image quality to the user.

Moreover, the applied backlight brightness is varied according to the change in the brightness level of the input image data, making it possible to reduce the noise phenomenon that can be generated according to sudden changes in the brightness of the image data.

FIG. 11 illustrates an example method of controlling a display device. First, data corresponding to a picture level of the display device for each illumination level that allows UGR values to be below a predetermined level is generated and stored (S101). The data is used for controlling the brightness of a backlight according to an APL. The data may include an equation as discussed above and/or a brightness control table as discussed above. An example method of determining the equation will be described with reference to FIG. 11. A method to determine the equation is also described above in the description of the device.

Illumination at the surroundings where the display device is installed is sensed (S102). The illumination at the surroundings may be sensed continuously or at one or more predetermined intervals. For instance, an illumination sensor 118 senses the illumination at the surroundings where the display device is installed and transfers sensed result information corresponding to the sensed surrounding illumination to a controller 122.

Data corresponding to the sensed surrounding illumination among the stored data is extracted (S103). For example, the controller 122 receives the sensed result information output through the illumination sensor 118 and extracts data corresponding to the received sensed result information from the memory unit 116.

An average picture level of input image data is detected (S104). The average picture level may be sensed continuously or at one or more predetermined intervals. For instance, the picture level detector 120 detects an APL for the input image data and outputs the detected APL to the controller 122.

The controller 122 sets a register value that controls the brightness of the backlight using the extracted data and the detected APL (S105). For example, the controller 122 uses the detected APL in the equation discussed above, thereby making it possible to determine the register value. Also, the controller 122 may extract a register value corresponding to the detected APL from the extracted brightness control table.

The controller 122 controls the brightness of the backlight using the set register value (S106). For instance, the controller 122 outputs the set register value to a backlight driver 114, and the backlight driver 114 provides driving current corresponding to the output register value to the backlight 112.

FIG. 12 illustrates an example method of obtaining an equation. First, a picture level of the display device for each illumination level that allows UGR values to be below a predetermined level is obtained (S201). Illumination levels in a predetermined range are grouped as one group (S202). Multiple groups of illumination levels may be determined to correspond to multiple, different ranges of illumination levels.

A maximum value and a minimum value of the picture level of the display device existing in each of the groups is confirmed (S203). A maximum value and a minimum value of an APL that can be displayed by input image data are also confirmed (S204).

A register value corresponding to the confirmed maximum value and a register value corresponding to the confirmed minimum value, of the picture level of the display device, are confirmed (S205). First coordinate information including of the register value corresponding to the maximum value and a minimum APL, and second coordinate information including the register value corresponding to the minimum value and a maximum APL are confirmed (S206). An equation corresponding thereto is obtained using the confirmed first coordinate information and second coordinate information (S207). The equation may be obtained using techniques similar to those discussed above with respect to FIGS. 6 and 7.

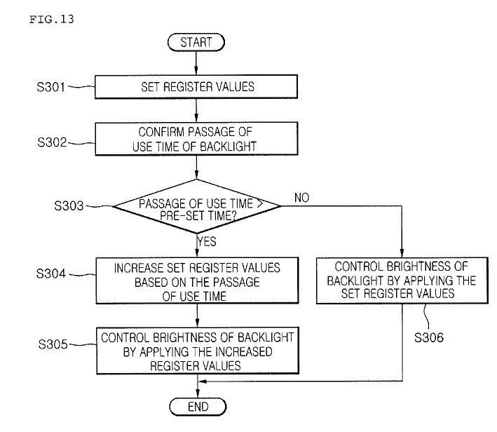

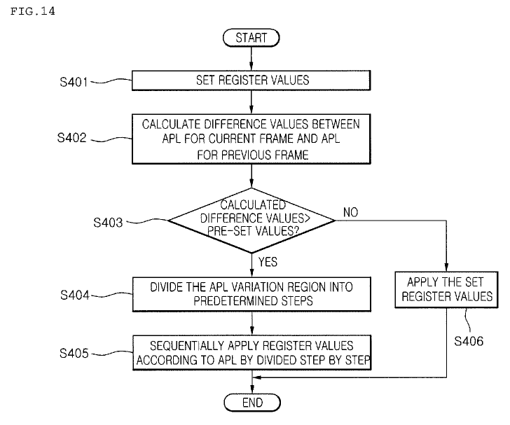

FIG. 13 illustrates an example method of changing register values. First, a register value corresponding to an APL of input image data is set through the above method (S301).

A controller 122 confirms the passage of use time of a backlight previously stored in a memory unit 116 (S302). The passage of use time may be determined continuously or at one or more predetermined intervals. For instance, the passage of use time of the backlight may be periodically checked and updated.

The controller 122 compares the confirmed passage of use time of the backlight with a pre-set time, thereby determining whether the passage of use time of the backlight passes by the pre-set time (S303). If the passage of use time of the backlight passes by the pre-set time, the controller 122 increases the set register value based on the passage of use time (S304). For instance, the brightness of the backlight is reduced corresponding to the passage of use time, such that the controller 122 changes the set register value according to the confirmed passage of use time. The set register value is increased in a manner that account for the reduced brightness of the backlight that results from passage of time.

The controller 122 controls the brightness of the backlight by applying the changed (e.g., increased) register value (S305).

If the passage of use time of the backlight does not pass by the pre-set time, the controller 122 controls the brightness of the backlight by applying the set register value (S306). For example, the controller 122 does not account for the reduced brightness of the backlight that results from passage of time until the reduced brightness passes a threshold.

FIG. 14 illustrates an example method of applying register values. As shown, the controller 122 sets the register value for controlling the brightness of the backlight through the method as above (S401), and calculates a difference value between an APL corresponding to a current frame and an APL corresponding to a previous frame accordingly (S402).

In addition, the controller 122 determines whether the calculated APL difference value exceeds the pre-set value (S403). If the calculated APL difference value exceeds the pre-set value, the controller 122 divides the variation region of the APL into predetermined steps. For instance, as shown in FIG. 10, the region between the APL corresponding to the previous frame and the APL corresponding to the current frame is divided into predetermined steps. The controller 122 sequentially applies the register value corresponding to the pertinent APL divided step by step (S405).

If the calculated APL difference value does not exceed the pre-set value, the controller 122 controls the brightness of the backlight by applying the set register value directly (s406). In this regard, when the APL does not undergo a dramatic sudden change, the set register value may be applied directly because noise resulting from the change is unlikely to be perceived by a user.

It will be understood that various modifications may be made without departing from the spirit and scope of the claims. For example, advantageous results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. A display device, comprising:
an illumination sensor configured to sense illumination of surroundings of a location where the display device is installed;
an image data receiver configured to receive image signals to be displayed;
a picture level detector configured to detect and output an average picture level of a signal received by the image data receiver; and
a controller configured to control brightness of a backlight associated with the display device based on the illumination sensed by the illumination sensor and the average pixel value output by the picture level detector.

2. The display device according to claim 1 further comprising:
a memory unit configured to store data related to backlight control values corresponding to illumination levels,
wherein the controller is configured to control brightness of the backlight associated with the display device based on the illumination sensed by the illumination sensor and the average pixel value output by the picture level detector by accessing, from the memory unit, data corresponding to an illumination level sensed by the illumination sensor and setting at least one register value that controls the brightness of the backlight using the accessed data and the average pixel value output by the picture level detector.

3. The display device according to claim 2, wherein the illumination levels are grouped for each of multiple predetermined ranges, and the data related to backlight control values corresponding to illumination levels stored in the memory unit includes an equation corresponding to each illumination group.

4. The display device according to claim 3, wherein the equation corresponding to each illumination group is a linear equation having average pixel level as an independent variable, a coefficient for the independent variable, and a constant, and the controller is configured to set the at least one register value as a result of the equation using the average pixel value output by the picture level detector.

5. The display device according to claim 2, wherein the illumination levels are grouped for each of multiple predetermined ranges, and the data related to backlight control values corresponding to illumination levels stored in the memory unit are register values for each average pixel level corresponding to each illumination group.

6. The display device according to claim 2, wherein the register values are determined based on a picture level of the display device needed to reduce unified glare rating values below specific levels for the illumination sensed by the illumination sensor.

7. The display device according to claim 2, wherein the register values are in inverse proportion to the illumination levels.

8. The display device according to claim 1, wherein the controller is further configured to control brightness of the backlight associated with the display device based on an amount of time during which the backlight has been in use.

9. The display device according to claim 8, wherein the controller is further configured to control brightness of the backlight associated with the display device based on the amount of time during which the backlight has been in use by determining the amount of time during which the backlight has been in use and adjusting at least one set register value that controls the brightness of the backlight in a manner corresponding to the determined amount of time during which the backlight has been in use.

10. The display device according to claim 1, wherein the controller is further configured to control brightness of the backlight associated with the display device based on an extent of a variation of the average pixel level output through the picture level detector.

11. The display device according to claim 10, wherein the controller is configured to control brightness of the backlight associated with the display device based on the extent of the variation of the average pixel level output through the picture level detector by determining the extent of the variation of the average pixel level output through the picture level detector, comparing the extent of the variation of the average pixel level to a pre-set level, determining whether the extent of the variation of the average pixel level exceeds the pre-set level based on the comparison, and, in response to a determination that the extent of the variation of the average pixel level exceeds the pre-set level, dividing a change period of the average pixel level into steps and sequentially adjusting the brightness of the backlight associated with the display device according to the steps.

12. A method of controlling a display device, comprising:
sensing, by an illumination sensor, illumination of surroundings of a location where the display device is installed;
receiving image signals to be displayed;
detecting an average picture level of a received signal; and
controlling, by a controller, brightness of a backlight associated with the display device based on the illumination sensed by the illumination sensor and the detected average pixel value.

13. The method of controlling a display device according to claim 12 further comprising:
storing, in a memory unit, data related to backlight control values corresponding to illumination levels,
wherein controlling, by the controller, brightness of the backlight associated with the display device based on the illumination sensed by the illumination sensor and the detected average pixel value comprises accessing, from the memory unit, data corresponding to an illumination level sensed by the illumination sensor and setting at least one register value that controls the brightness of the backlight using the accessed data and the detected average pixel value.

14. The method of controlling a display device according to claim 13,
wherein storing, in the memory unit, data related to backlight control values corresponding to illumination levels comprises grouping the illumination levels for each of multiple ranges and storing an equation corresponding to each illumination group.

15. The method of controlling a display device according to claim 13, wherein storing, in the memory unit, data related to backlight control values corresponding to illumination levels comprises grouping the illumination levels for each of multiple ranges and storing register values for each average pixel level corresponding to each illumination group.

16. The method of controlling a display device according to claim 12, wherein controlling, by the controller, brightness of the backlight associated with the display device based on the illumination sensed by the illumination sensor and the detected average pixel value comprises controlling brightness of the backlight associated with the display device based on an amount of time during which the backlight has been in use.

17. The method of controlling a display device according to claim 16, wherein controlling brightness of the backlight associated with the display device based on an amount of time during which the backlight has been in use comprises:
determining the amount of time during which the backlight has been in use; and
adjusting at least one set register value that controls the brightness of the backlight in a manner corresponding to the determined amount of time during which the backlight has been in use.

18. The method of controlling a display device according to claim 12, wherein controlling, by the controller, brightness of the backlight associated with the display device based on the illumination sensed by the illumination sensor and the detected average pixel value comprises controlling brightness of the backlight associated with the display device based on an extent of a variation of the detected average pixel level.

19. The method of controlling a display device according to claim 18, wherein controlling brightness of the backlight associated with the display device based on an extent of a variation of the detected average pixel level comprises:
determining the extent of the variation of the average pixel level output through the picture level detector;
comparing the extent of the variation of the average pixel level to a pre-set level;
determining whether the extent of the variation of the average pixel level exceeds the pre-set level based on the comparison; and
in response to a determination that the extent of the variation of the average pixel level exceeds the pre-set level, dividing a change period of the average pixel level into steps and sequentially adjusting the brightness of the backlight associated with the display device according to the steps.

20. At least one computer-readable storage medium encoded with executable instructions that, when executed by a processor, cause the processor to perform operations comprising:
controlling an illumination sensor to sense illumination of surroundings of a location where a display device is installed;
receiving image signals to be displayed;
detecting an average picture level of a received signal; and
controlling brightness of a backlight associated with the display device based on the illumination sensed by the illumination sensor and the detected average pixel value.
